(19) United States
(12) Patent Application Publication
(10) Pub. No.: US 2021/0249179 A1
(43) Pub. Date: Aug. 12, 2021

(54) LOW-LOSS SPIRAL COIL

(71) Applicant: ELECTRONICS AND TELECOMMUNICATIONS RESEARCH INSTITUTE, Daejeon (KR)

(72) Inventors: Jung Ick MOON, Daejeon (KR); In Kui CHO, Daejeon (KR); Sang-Won KIM, Daejeon (KR); Seong-Min KIM, Daejeon (KR); Ho Jin LEE, Daejeon (KR); Je Hoon YUN, Daejeon (KR); Dong Won JANG, Daejeon (KR)

(21) Appl. No.: 17/054,267

(22) PCT Filed: May 10, 2019
(86) PCT No.: PCT/KR2019/005626

§ 371 Date: Nov. 10, 2020

(30) Foreign Application Priority Data
May 11, 2018 (KR) 10-2018-0054386
Oct. 17, 2018 (KR) 10-2018-0123789

(51) Int. Cl. H01F 27/28

(52) U.S. Cl. CPC H01F 27/2823

(57) ABSTRACT

A low-loss spiral coil includes a conducting wire wound N turns of which a width of each of wires corresponding to each of sections of the conducting wire is determined by setting an entire width of the conducting wire to be a width of M sections of the conducting wire, and then determining the width of each of the wires such that a resistance of the spiral coil formed based on the width of the M sections is minimized.

### TECHNICAL FIELD

Example embodiments relate to a low-loss spiral coil, and more particularly, to a method of designing a spiral coil generating or receiving a magnetic field to have a low resistance in order to improve performance of the spiral coil.

### BACKGROUND ART

An existing type of coil configured to generate a magnetic field may be formed by winding a conducting wire having a certain thickness by a plurality of layers or turns. When embedding such a coil in a small device, the coil may be formed to be extremely thin using a printed circuit board (PCB) process.

For a small coil, an entire length of a conducting wire of the coil may need to be great to generate numerous magnetic fields. However, a resistance of the coil may increase in proportion to the length of the conducting wire. As the entire length of the conducting wire increases, a quality factor (Q-factor) of the coil may be degraded, and heating or heat generation may be intensified causing various issues around the coil.

Thus, there is ongoing research to improve a Q-factor of a coil despite a long length of a conducting wire of the coil.

### DISCLOSURE OF INVENTION

### Technical Goals

An aspect provides a low-loss spiral coil, and a method of designing the spiral coil configured to generate or receive a magnetic field so as to have a low level of resistance although having the same outer radius and the same number of turns as those of an existing thin film coil.

### Technical Solutions

According to an example embodiment, there is provided a spiral coil including a conducting wire wound N turns. A width of each of wires corresponding to each of sections of the conducting wire may be determined by setting an entire width of the conducting wire to be a width of M sections of the conducting wire, and then determining the width of each of the wires such that a resistance of the spiral coil formed based on the width of the M sections is minimized.

Widths of the wires may change in a direction from an outer radius of the spiral coil towards a center of the spiral coil.

The widths of the wires may decrease by a predetermined reduction rate.

In the spiral coil of which the width of each of the wires is determined such that the resistance is minimized, as widths of wires corresponding to two neighboring sections of the conducting wire decrease by a uniform rate, an interval between the wires corresponding to the two neighboring sections may be formed.

In the spiral coil of which the width of each of the wires is determined such that the resistance is minimized, as widths of wires corresponding to two neighboring sections of the conducting wire decrease in proportion to a width of each of the wires, an interval between the wires corresponding to the two neighboring sections may be formed.

According to another example embodiment, there is provided a spiral coil including a conducting wire wound N turns. Widths of wires corresponding to each of sections of the conducting wire may change in a direction from an outer radius of the spiral coil towards a center of the spiral coil such that a resistance of the spiral coil is minimized.

When the widths of the wires increase in the direction from the outer radius towards the center, a width difference between wires corresponding to two neighboring sections of the conducting wire may be constant, or increase or decrease.

When the widths of the wires increase in the direction from the outer radius towards the center, an interval between wires corresponding to two neighboring sections of the conducting wire may be 0 or constant, or increase by a predetermined rate or an arbitrary rate or decrease by a predetermined rate or an arbitrary rate.

When the widths of the wires decrease in the direction from the outer radius towards the center, a width difference between wires corresponding to two neighboring sections of the conducting wire may be constant, or increase or decrease.

When the widths of the wires decrease in the direction from the outer radius towards the center, an interval between wires corresponding to two neighboring sections of the conducting wire may be 0 or constant, or increase by a predetermined rate or an arbitrary rate or decrease by a predetermined rate or an arbitrary rate.

According to still another example embodiment, there is provided a spiral coil including a conducting wire wound N turns. An interval between wires corresponding to each of sections of the conducting wire may change in a direction from an outer radius of the spiral coil towards a center of the spiral coil such that a resistance of the spiral coil is minimized.

When the interval between the wires increases in the direction from the outer radius towards the center, widths of wires corresponding to two neighboring sections of the conducting wire may be constant, or increase or decrease.

When the interval between the wires increases in the direction from the outer radius towards the center, a width difference between wires corresponding to two neighboring sections of the conducting wire may be constant, or increase or decrease.

When the interval between the wires decreases in the direction from the outer radius towards the center, widths of wires corresponding to two neighboring sections of the conducting wire may be constant, or increase or decrease.

When the interval between the wires decreases in the direction from the outer radius towards the center, a width difference between wires corresponding to two neighboring sections of the conducting wire may be constant, or increase or decrease.

According to yet another example embodiment, there is provided a spiral coil including a conducting wire wound N turns. A width difference between wires corresponding to each of sections of the conducting wire may change in a direction from an outer radius of the spiral coil towards a center of the spiral coil such that a resistance of the spiral coil is minimized.

When the width difference between the wires increases in the direction from the outer radius towards the center, an interval between wires corresponding to two neighboring sections of the conducting wire may be 0 or constant, or increase by a predetermined rate or an arbitrary rate or decrease by a predetermined rate or an arbitrary rate.

When the width difference between the wires decreases in the direction from the outer radius towards the center, an interval between wires corresponding to two neighboring sections of the conducting wire may be 0 or constant, or increase by a predetermined rate or an arbitrary rate or decrease by a predetermined rate or an arbitrary rate.

### Advantageous Effects

According to example embodiments, it is possible to design a spiral coil configured to generate or receive a magnetic field to have a low resistance, thereby improving performance of the coil.

### BRIEF DESCRIPTION OF DRAWINGS

FIGS. 1A and 1B are diagrams illustrating a structure of a spiral coil according to an example embodiment.

FIG. 2 is a diagram illustrating a portion of a cross section of a spiral coil according to an example embodiment.

FIGS. 3A through 3C are diagrams illustrating a first method of calculating a width of a conducting wire of a spiral coil according to an example embodiment.

FIGS. 4A through 4E are diagrams illustrating a second method of calculating a width of a conducting wire of a spiral coil according to an example embodiment.

FIG. 5 is a diagram illustrating an example of a spiral coil in which a conducting wire is wound five turns according to an example embodiment.

FIG. 6 is a diagram illustrating a first result obtained by comparing normal resistances of a conducting wire divided into 12 wires according to an example embodiment.

FIG. 7 is a diagram illustrating a second result obtained by comparing normal resistances of a conducting wire divided into 12 wires according to an example embodiment.

### BEST MODE FOR CARRYING OUT THE INVENTION

Hereinafter, some example embodiments will be described in detail with reference to the accompanying drawings. However, various alterations and modifications may be made to the examples. Here, the examples are not construed as limited to the disclosure and should be understood to include all changes, equivalents, and replacements within the idea and the technical scope of the disclosure.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, operations, elements, and/or components, but do not preclude the presence or addition of one or more other features, integers, operations, elements, components, and/or groups thereof.

Unless otherwise defined, all terms, including technical and scientific terms, used herein have the same meaning as commonly understood by one of ordinary skill in the art to which this disclosure pertains based on an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

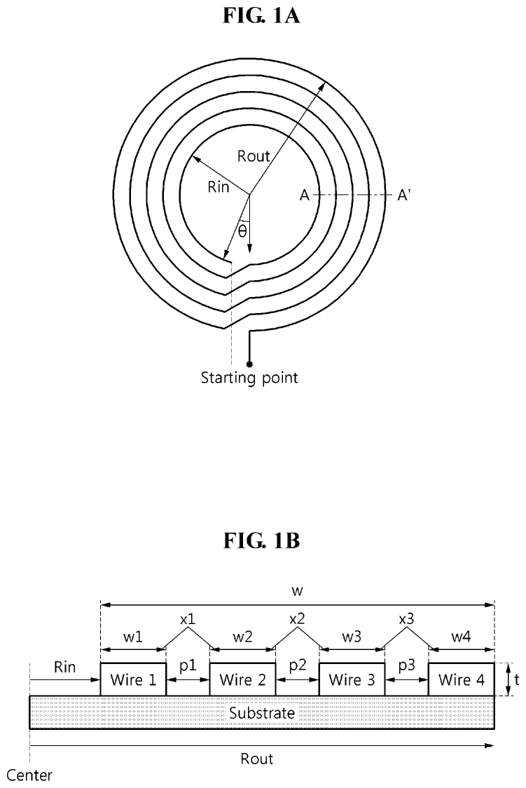

FIGS. 1A and 1B are diagrams illustrating a structure of a spiral coil according to an example embodiment.

FIG. 1A illustrates a structure of a spiral coil according to an example embodiment. The spiral coil may be provided in a structure in which a conducting wire is formed in a circle having a predetermined radius, and the conducting wire is wound towards an inner turn from a point at which an angle of θ is formed with a starting point. The spiral coil of such structure may be used to improve inductance as a length of the conducting wire increases, and be designed with sections of the conducting wire having different radii.

That is, a general-type spiral coil may be formed in a helical structure having a plurality of physical layers by winding, a plurality of times, a conducting wire to have a same diameter in the layers to increase a magnetic field strength, and thus it may not be easy to embed such a general spiral coil in a small device. However, the spiral coil illustrated in FIG. 1A is designed such that the conducting wire has a single-layer or two-layer structure having different radii, and thus it is possible to embed the spiral coil in a small device. As illustrated in FIG. 1A, a distance from a center of the spiral coil to a first wire of the conducting wire indicates an inner radius Rin, and a distance from the center to a last wire of the conducting wire indicates an outer radius Rout.

FIG. 1B illustrates a structure of a cross section of a spiral coil according to an example embodiment. In detail, as illustrated in the cross section cut by a A-A′ line of FIG. 1A, wire 1, wire 2, . . . , wire N which correspond to sections of a conducting wire wound N turns are disposed at intervals.

The spiral coil may be provided as in various examples, as a non-limiting example, the following examples.

### First Example

In a spiral coil having a conducting wire wound N turns, a width of each of wires respectively corresponding to sections of the conducting wire may change in a direction from an outer radius of the spiral coil towards a center of the spiral coil. Here, the conducting wire is assumed to be wound four turns for convenience of description.

(I) When widths, for example, w1, w2, w3, and w4, of the wires, for example, wire 1, wire 2, wire 3, and wire 4, respectively corresponding to the sections increase in the direction from the outer radius towards the center, a width difference, for example, x1, x2, and x3, between wires corresponding to two neighboring sections of the conducting wire may be constant, or increase or decrease.

(II) When the widths w1, w2, w3, and w4 of the wires wire 1, wire 2, wire 3, and wire 4 respectively corresponding to the sections increase in the direction from the outer radius towards the center, an interval, for example, p1, p2, and p3, between wires corresponding to two neighboring sections of the conducting wire may be 0 or constant, or increase by a predetermined rate or arbitrary rate or decrease by a predetermined rate or arbitrary rate.

(III) When the widths w1, w2, w3, and w4 of the wires wire 1, wire 2, wire 3, and wire 4 respectively corresponding to the sections decrease in the direction from the outer radius towards the center, the width differences x1, x2, and x3 between wires corresponding to two neighboring sections of the conducting wire may be constant, or increase or decrease.

(IV) When the widths w1, w2, w3, and w4 of the wires wire 1, wire 2, wire 3, and wire 4 respectively corresponding to the sections decrease in the direction from the outer radius towards the center, the intervals p1, p2, and p3 between widths of wires corresponding to two neighboring sections of the conducting wire may be 0 or constant, or increase by a predetermined rate or arbitrary rate or decrease by a predetermined rate or arbitrary rate.

(V) When the widths w1, w2, w3, and w4 of the wires wire 1, wire 2, wire 3, and wire 4 respectively corresponding to the sections are in a mixed situation of increasing and decreasing in the direction from the outer radius towards the center, the width differences x1, x2, and x3 between wires corresponding to two neighboring sections of the conducting wire may be constant, or increase or decrease.

(VI) When the widths w1, w2, w3, and w4 of the wires wire 1, wire 2, wire 3, and wire 4 respectively corresponding to the sections are in a mixed situation of increasing or decreasing in the direction from the outer radius towards the center, the intervals p1, p2, and p3 between widths of wires corresponding to two neighboring sections of the conducting wire may be 0 or constant, or increase by a predetermined rate or arbitrary rate or decrease by a predetermined rate or arbitrary rate.

### Second Example

In a spiral coil having a conducting wire wound N turns, an interval between wires respectively corresponding to sections of the conducting wire may change in a direction from an outer radius of the spiral coil towards a center of the spiral coil.

(I) When an interval, for example, p1, p2, and p3, between widths of wires, for example, wire 1, wire 2, wire 3, and wire 4, respectively corresponding to the sections of the conducting wire is 0 in the direction from the outer radius towards the center, a width, for example, w1, w2, w3, and w4, of wires corresponding to two neighboring sections of the conducting wire may be constant, or increase or decrease.

(II) When the intervals p1, p2, and p3 between the widths of the wires wire 1, wire 2, wire 3, and wire 4 respectively corresponding to the sections of the conducting wire are 0 in the direction from the outer radius towards the center, a width difference, for example, x1, x2, and x3, between wires corresponding to two neighboring sections of the conducting wire may be constant, or increase or decrease.

(III) When the intervals p1, p2, and p3 between the widths of the wires wire 1, wire 2, wire 3, and wire 4 respectively corresponding to the sections of the conducting wire are constant in the direction from the outer radius towards the center, the widths w1, w2, w3, and w4 of the wires corresponding to two neighboring sections of the conducting wire may be constant, or increase or decrease.

(IV) When the intervals p1, p2, and p3 between the widths of the wires wire 1, wire 2, wire 3, and wire 4 respectively corresponding to the sections of the conducting wire are constant in the direction from the outer radius towards the center, the width differences x1, x2, and x3 between wires corresponding to two neighboring sections of the conducting wire may be constant, or increase or decrease.

(V) When the intervals p1, p2, and p3 between the widths of the wires wire 1, wire 2, wire 3, and wire 4 respectively corresponding to the sections of the conducting wire increase by a predetermined rate or arbitrary rate in the direction from the outer radius towards the center, the widths w1, w2, w3, and w4 of the wires corresponding to two neighboring sections of the conducting wire may be constant, or increase or decrease.

(VI) When the intervals p1, p2, and p3 between the widths of the wires wire 1, wire 2, wire 3, and wire 4 respectively corresponding to the sections of the conducting wire increase by a predetermined rate or arbitrary rate in the direction from the outer radius towards the center, the width differences x1, x2, and x3 between wires corresponding to two neighboring sections of the conducting wire may be constant, or increase or decrease.

(VII) When the intervals p1, p2, and p3 between the widths of the wires wire 1, wire 2, wire 3, and wire 4 respectively corresponding to the sections of the conducting wire decrease by a predetermined rate or arbitrary rate in the direction from the outer radius towards the center, the widths w1, w2, w3, and w4 of the wires corresponding to two neighboring sections of the conducting wire may be constant, or increase or decrease.

(VIII) When the intervals p1, p2, and p3 between the widths of the wires wire 1, wire 2, wire 3, and wire 4 respectively corresponding to the sections of the conducting wire decrease by a predetermined rate or arbitrary rate in the direction from the outer radius towards the center, the width differences x1, x2, and x3 between wires corresponding to two neighboring sections of the conducting wire may be constant, or increase or decrease.

### Third Example

In a spiral coil having a conducting wire wound N turns, a width difference between wires respectively corresponding to sections of the conducting wire may change in a direction from an outer radius of the spiral coil towards a center of the spiral coil.

(I) When a width difference, for example, x1, x2, and x3, between wires, for example, wire 1, wire 2, wire 3, and wire 4, respectively corresponding to the sections of the conducting wire increases in the direction from the outer radius towards the center, an interval, for example, p1, p2, and p3, between wires corresponding to two neighboring sections of the conducting wire may be 0 or constant, or increase by a predetermined rate or arbitrary rate or decrease by a predetermined rate or arbitrary rate.

(II) When the width differences x1, x2, and x3 between the wires wire 1, wire 2, wire 3, and wire 4 respectively corresponding to the sections of the conducting wire decrease in the direction from the outer radius towards the center, the intervals p1, p2, and p3 between wires corresponding to two neighboring sections of the conducting wire may be 0 or constant, or increase by a predetermined rate or arbitrary rate or decrease by a predetermined rate or arbitrary rate.

(III) When the width differences x1, x2, and x3 between the wires wire 1, wire 2, wire 3, and wire 4 respectively corresponding to the sections of the conducting wire are in a mixed situation of increasing and decreasing in the direction from the outer radius towards the center, the intervals p1, p2, and p3 between wires corresponding to two neighboring sections of the conducting wire may be 0 or constant, or increase by a predetermined rate or arbitrary rate or decrease by a predetermined rate or arbitrary rate.

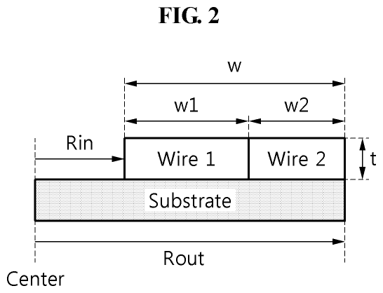

FIG. 2 is a diagram illustrating a portion of a cross section of a spiral coil according to an example embodiment.

Various types or examples of spiral coil have been described above with reference to FIGS. 1A and 1B. According to an example embodiment, there is provided a method of minimizing a direct current (DC) resistance of a wire corresponding to each of a plurality of sections included in a spiral coil and changing a width of the wire, thereby reducing an entire resistance of the spiral coil.

In a spiral coil including a conducting wire wound N turns, an entire width of the conducting wire of the spiral coil may be set to be a width of wires corresponding to M sections of the conducting wire, and the width may be determined such that a resistance of the spiral coil formed based on the width of the wires corresponding to the M sections is minimized.

Here, widths of wires respectively corresponding to the sections of the spiral coil may change in a direction from an outer radius of the spiral coil towards a center of the spiral coil, and decrease by a predetermined reduction rate such that a resistance of the spiral coil is minimized.

For example, when an interval p between wires included in the spiral coil is 0, which indicates that the wires are connected to each other, and a thickness t of the conducting wire is less than a skin depth, a DC resistance and an alternating current (AC) resistance of the conducting wire are almost the same, and thus only the DC resistance may be considered to reduce a resistance of the spiral coil.

Referring to FIG. 2 a DC resistance of the spiral coil may be calculated based on a function of widths w1 and w2 of two wires. Here, w=w1+w2, and thus the DC resistance may be defined by a function of only w1 or w2. A radius of a wire required to calculate the DC resistance may be set to be from a center of the spiral coil to a central, point of the wire formed in a radial direction. For convenience of calculation, the radius may also be set based on a starting point or an endpoint of the wire.

For example, a radius of wire 1 may be selected to be one of Rin, Rin+w1/2, Rin+w1. However, such standard may need to be consistently applied to other wires.

Thus, a DC resistance of a conducting wire included in the spiral coil may be defined by a function of only w1 or w2 as represented by Equation 1.

R=Rw1+Rw2 [Equation 1]

In Equation 1, a DC resistance R may be determined by a thickness or a conductivity of the conducting wire.

The DC resistance of the conducting wire included in the spiral coil may be divided by w1 or w2 that satisfies a minimum resistance condition as represented by Equation 2.

$$\frac{\partial R}{\partial Rw 1} = 0 or \frac{\partial R}{\partial Rw 2} = 0 \qquad [ Equation 2 ]$$

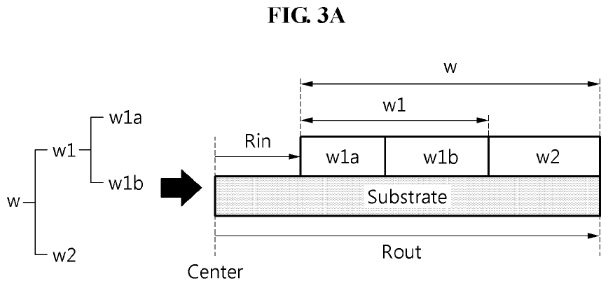

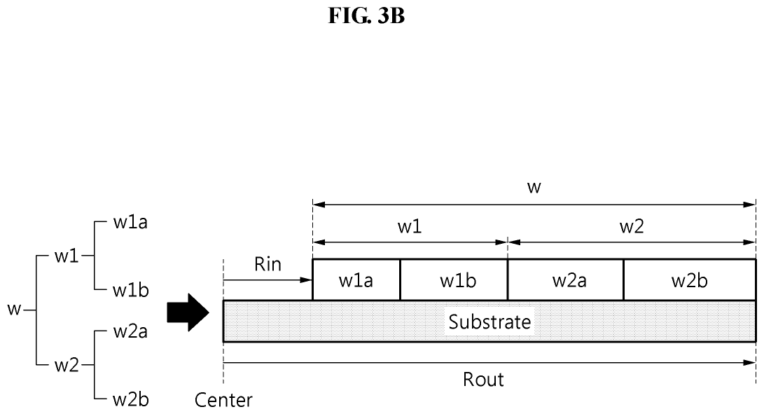

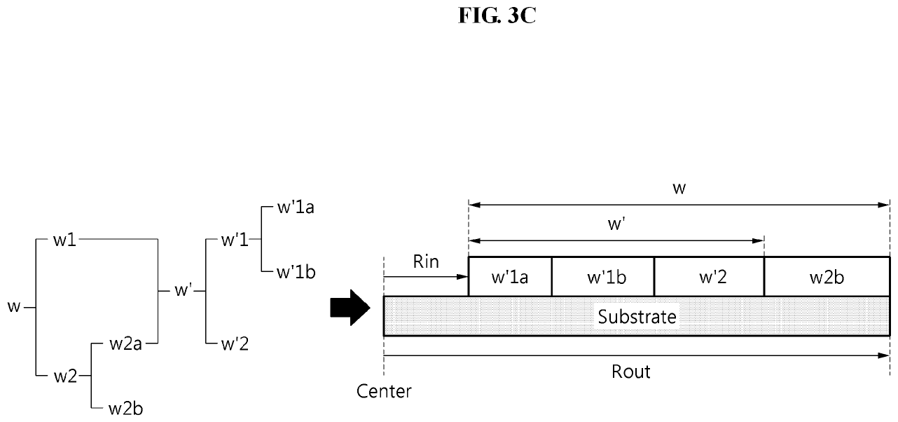

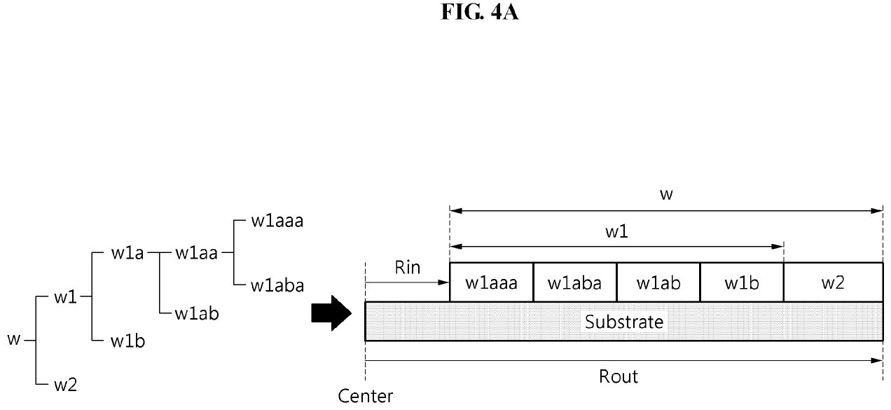

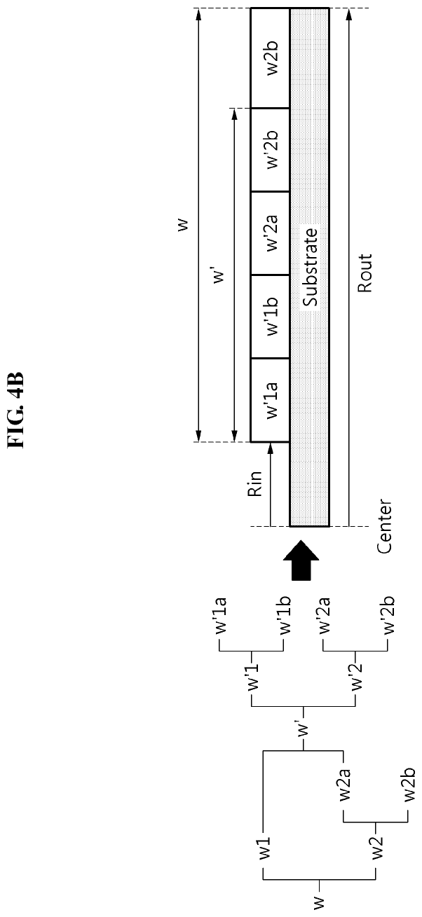

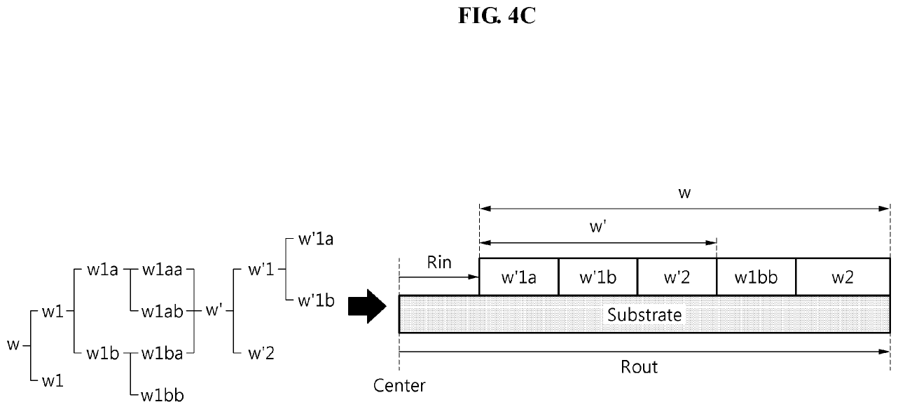

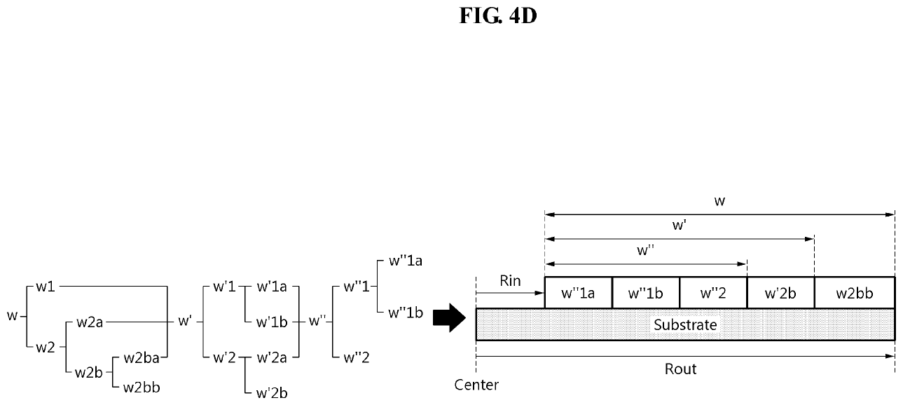

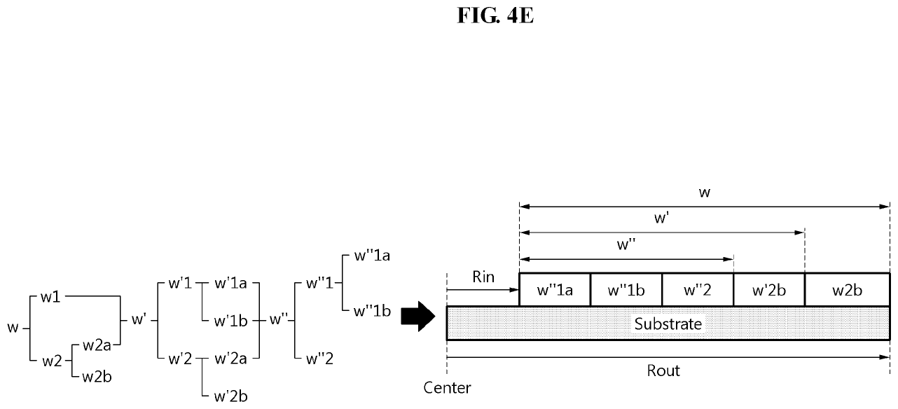

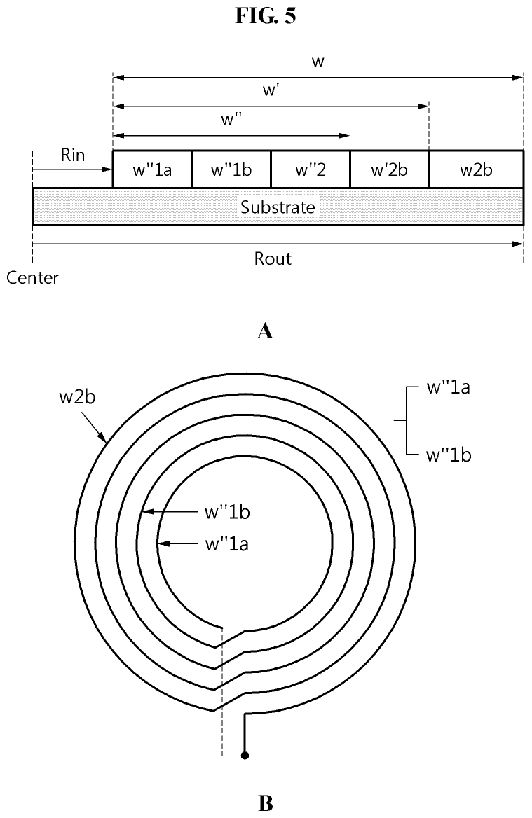

That is, when an outer radius (Rout) and an inner radius (Rin) of the spiral coil are set and the number of turns is 2, the method may be used to design a low-loss spiral coil by obtaining a width, for example, w1 and w2, of each wire. The method may employ a division system to determine a width of each wire of the conducting wire of the spiral coil having an arbitrary number of turns. The division system may be as illustrated in FIGS. 3A through 3C, and 4A through 4E. The division system may be a list of the numbers of cases to divide the conducting wire. Fundamentally, a section having a large difference in wire ratio may be repeatedly divided such that a DC resistance of the conducting wire is minimized.

When a wire width is determined through the division system, an interval between wires of the conducting wire included in the spiral coil may be determined by two different methods.

By a first method, neighboring wires may have a uniform interval. When a width is divided into w1 and w2 and an interval between the wires is p, w1 may be w1−p/2, and w2 may be w2−p/2, which may be reduced by p/2 from each original wire width.

By a second method, an interval between neighboring wires may be determined in proportion to a width of each wire. When the interval is determined by applying the first method, a large width and a small width may be reduced by a same width, and thus the first method may not match a wire width determining logic described with reference to FIG. 2. Thus, an interval between neighboring wires may be reduced in proportion to a width of each wire, for example, w1−p*w1/(w1+w2) for w1 and w2−p*w2/(w1+w2) for w2. Here, when an interval p between neighboring wires is extremely small, there may be little difference between the two methods. However, when an interval p between neighboring wires is relatively large, a difference in resistance may occur based on which one of the two methods is employed.

FIG. 5 is a diagram illustrating an example of a spiral coil in which a conducting wire is wound five turns according to an example embodiment.

Referring to FIGS. 2 through 4E, a width of a conducting wire included in a spiral coil may be initially calculated. However, such calculation may be applied to the conducting wire divided into two wires. Thus, when the conducting wire is divided into three or more wires, it may not be possible to calculate a width of each of all the wires that minimizes a resistance of the spiral coil by applying such calculation once.

For example, when an outer radius and an inner radius of a spiral coil embodied as illustrated in A and B of FIG. 5 are 20 mm and 10 mm, respectively, an interval p between wires is 0, and the number of turns is 5, widths of wires determined as illustrated in FIG. 4E may be as indicated in Table 1 below.

TABLE 1

| Wire number | Wire name | Wire width (mm) | Wire radius (mm) |
|---|---|---|---|
| 1 | w″1a | 1.02 | 10.00-11.02 |
| 2 | w″1b | 1.13 | 11.02-12.15 |
| 3 | w″2 | 2.62 | 12.15-14.77 |
| 4 | w′2b | 2.05 | 14.77-16.82 |
| 5 | w2b | 3.18 | 16.82-20.00 |

Referring to Table 1 above, widths of wire 4 and wire 5 are 2.05 mm and 3.18 mm, respectively. However, when a section from 14.77 to 16.82 is divided into two wires, the widths of wire 4 and wire 5 may need to be modified to 2.42 mm and 2.81 mm, respectively, by applying the division method described with reference to FIG. 2. Thus, a width of each wire may be re-calculated based on the division method described with reference to FIG. 2 for each section, and results of recalculations on sections in order of wire 5-wire 4, wire 4-wire 3, and lastly wire 2-wire 1 based on the division method described with reference to FIG. 2 may be as indicated in Table 2 below.

TABLE 2

| Wire | Wire | Wire width-initial | Wire width- | Constant wire |
|---|---|---|---|---|
| number | name | calculation (mm) | recalculation (mm) | width (mm) |
| 1 | w″1a | 1.02 | 1.23 | 2 |
| 2 | w″1b | 1.13 | 1.39 | 2 |
| 3 | w″2 | 2.62 | 1.83 | 2 |
| 4 | w′2b | 2.05 | 2.42 | 2 |
| 5 | w2b | 3.18 | 2.81 | 2 |

| | | | |
|---|---|---|---|
| Normalized | 104.5 | 98.7 | 100 |
| resistance (%) | | | |

Referring to Table 2, when a resistance of a coil having a same wire width is 100%, the resistance may be relatively higher as 104.5% in a case of a wire width divided through an initial calculation. However, when the wire width is modified through a recalculation for each section, the resistance may be reduced to 98.7%.

Alternatively, wire widths may be re-calculated in an order starting from a greatest difference without sequentially setting sections for the recalculation. For example, it is verified that a reduction rate of a section between wire 3 and wire 2 is the greatest, for example, (2.62−1.13)/2.62=0.43, as a result of an initial calculation of wire widths. According to an example embodiment, a width of wire 2 and a width of wire 3 may be modified by recalculating the width (2.62) of wire 3 and the width (1.13) of wire 2.

Thus, it is possible to modify a wire width by repeating a process of identifying one with a relatively great difference and recalculating first a corresponding width. Thus, applying such process may result in a lower resistance value, compared to a method of recalculating by setting sections in sequential order (refer to Table 2). The result is indicated in Table 3.

TABLE 3

| | | Wire width- | Wire width- | Wire width- | |
|---|---|---|---|---|---|
| | | initial | Table 2 | repeated | |
| Wire | Wire | calculation | recalculation | modification | Wire width |
| number | name | (mm) | (mm) | (mm) | (mm) |
| 1 | w″1a | 1.02 | 1.02 | 1.46 | 2 |
| 2 | w″1b | 1.13 | 1.74 | 1.70 | 2 |
| 3 | w″2 | 2.62 | 2.01 | 1.96 | 2 |
| 4 | w′2b | 2.05 | 2.05 | 2.26 | 2 |
| 5 | w2b | 3.18 | 3.18 | 2.62 | 2 |

| | | | | |
|---|---|---|---|---|
| Normalized | 104.5 | 99.9 | 96.3 | 100 |
| resistance (%) | | | | |

Here, by repeatedly modifying a wire width through the process of identifying one with a relatively great difference and recalculating first a corresponding width, a wire width corresponding to each of sections in a direction from an outer radius of the spiral coil towards a center of the spiral coil may have a reduction rate, for example, 86%-87% as indicated in Table 4.

TABLE 4

| | | Wire-initial | | Wire-repeated | |
|---|---|---|---|---|---|
| | | calculation model | | calculation model | |
| | | Wire | Reduction | Wire | Reduction |
| Wire | Wire | width | rate | width | rate |
| number | name | (mm) | (%) | (mm) | (%) |
| 1 | w″1a | 1.02 | 90 | 1.46 | 86 |
| | | | (=1 − (1.13 − | | |
| | | | 1.02)/1.13) | | |
| 2 | w″1b | 1.13 | 43 | 1.70 | 87 |
| 3 | w″2 | 2.62 | 127 | 1.96 | 87 |
| 4 | w′2b | 2.05 | 64 | 2.26 | 86 |
| 5 | w2b | 3.18 | 100 | 2.62 | 100 |

The method of calculating a wire width that satisfies a minimum resistance through repeated calculations after identifying a deviation in wire width for each section may be performed by combining sections and neighboring wires with a great deviation for the calculation, and by combining three or more wires into one and using the division system described above with reference to FIGS. 3A through 3C, and 4A through 4E.

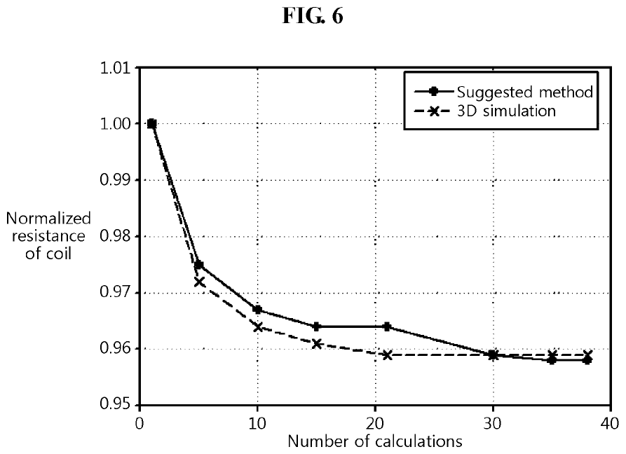

FIG. 6 is a diagram illustrating a first result obtained by comparing normal resistances of a conducting wire divided into 12 wires according to an example embodiment.

FIG. 6 illustrates a result of comparing normal resistances of a spiral coil obtained through repeated calculations by determining a width difference between wires of each section and connecting neighboring wires, and a normal resistance of a spiral coil obtained using a commercial electromagnetic simulation.

Referring to Table 4 above, when a conducting wire decreases by a predetermined reduction rate, a resistance of a spiral coil may be reduced. Thus, by designing the spiral coil such that a width of each of wires included in the spiral coil decreases by a reduction rate from an external wire to an internal wire, the spiral coil may have a minimum resistance.

However, to design the spiral coil having the minimum resistance, the reduction rate and an outermost wire width that may differ based on an outer radius, an inner radius, and the number of turns may be applied as parameters. The reduction rate and the outermost wire width may be determined using the division system described with reference to FIGS. 3A through 3d, and 4A through 4E.

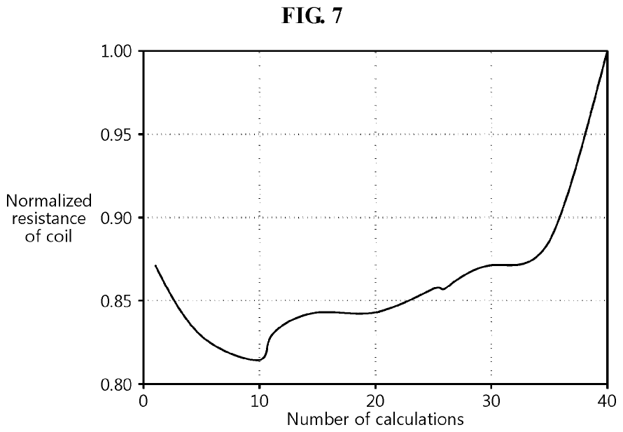

FIG. 7 is a diagram illustrating a second result obtained by comparing normal resistances of a conducting wire divided into 12 wires according to an example embodiment

When a thickness t of a conducting wire is similar to a skin depth or greater than the skin depth, an AC resistance of a spiral coil may become greater than a DC resistance thereof, and an entire resistance may increase. Thus, it may not be easy to design a low-loss spiral coil only using the method described above. Thus, another method may be used to design a low-loss spiral coil by obtaining a spiral coil model for each calculation step while applying the division system described above, and obtaining a resistance by using an electromagnetic simulation, and analyzing a characteristic thereof.

For example, when a spiral coil in which a conducting wire has a thickness similar to the skin depth, an outer radius and an inner radius are 40 mm and 16 mm, respectively, an wire interval is 0.2 mm, and the conducting wire is wound 7 turns, a resistance of a model of the spiral coil obtained in each calculation step may be as illustrated in FIG. 7.

Referring to FIG. 7, a resistance of the spiral coil may be a minimum value as a result of 10th calculation. However, the resistance may increase in subsequent calculations. Thus, an optimal spiral coil model may be selected based on a characteristic of a resistance of a spiral coil model obtained in each calculation step, and an unnecessary calculation step may be removed or reduced based on a tendency of increase or decrease of the resistance.

Table 5 indicates a result of comparing resistances of the spiral coil based on division steps and methods.

TABLE 5

| | | | | Wire width | |
|---|---|---|---|---|---|
| | #1 of | #10 of | #40 of | decreasing by | Same wire |
| Coil | FIG. 7 | FIG. 7 | FIG. 7 | predetermined rate | width |
| Normal | 87.1 | 81.4 | 100 | 101.4 | 118.5 |
| resistance | | | | | |
| (%) | | | | | |

Referring to Table 5, a resistance of #10 coil is minimum, and #40 coil and a model in which a wire width decreases by a predetermined rate are similar in terms of wire width and have a similar resistance. However, a coil in which wires have a same width may have an approximately 37% difference from a minimum resistance. Thus, for a spiral coil having a thickness of a conducting wire that is greater than or equal to a skin depth, the coil designing method described herein may also be used.

The units described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

1. A spiral coil comprising:
a conducting wire wound N turns,
wherein a width of each of wires corresponding to each of sections of the conducting wire is determined by setting an entire width of the conducting wire to be a width of M sections of the conducting wire, and then determining the width of each of the wires such that a resistance of the spiral coil formed based on the width of the M sections is minimized.

2. The spiral coil of claim 1, wherein widths of the wires are configured to change in a direction from an outer radius of the spiral coil towards a center of the spiral coil.

3. The spiral coil of claim 2, wherein the widths of the wires are configured to decrease by a predetermined reduction rate.

4. The spiral coil of claim 1, of which the width of each of the wires is determined such that the resistance is minimized,
wherein, as widths of wires corresponding to two neighboring sections of the conducting wire decrease by a uniform rate, an interval between the wires corresponding to the two neighboring sections is formed.

5. The spiral coil of claim 1, of which the width of each of the wires is determined such that the resistance is minimized,
wherein, as widths of wires corresponding to two neighboring sections of the conducting wire decrease in proportion to a width of each of the wires, an interval between the wires corresponding to the two neighboring sections is formed.

6. A spiral coil comprising:
a conducting wire wound N turns,
wherein widths of wires corresponding to each of sections of the conducting wire are configured to change in a direction from an outer radius of the spiral coil towards a center of the spiral coil such that a resistance of the spiral coil is minimized.

7. The spiral coil of claim 6, wherein, when the widths of the wires increase in the direction from the outer radius towards the center, a width difference between wires corresponding to two neighboring sections of the conducting wire is constant, or increases or decreases.

8. The spiral coil of claim 6, wherein, when the widths of the wires increase in the direction from the outer radius towards the center, an interval between wires corresponding to two neighboring sections of the conducting wire is 0 or constant, or increases by a predetermined rate or an arbitrary rate or decreases by a predetermined rate or an arbitrary rate.

9. The spiral coil of claim 6, wherein, when the widths of the wires decrease in the direction from the outer radius towards the center, a width difference between wires corresponding to two neighboring sections of the conducting wire is constant, or increases or decreases.

10. The spiral coil of claim 6, wherein, when the widths of the wires decrease in the direction from the outer radius towards the center, an interval between wires corresponding to two neighboring sections of the conducting wire is 0 or constant, or increases by a predetermined rate or an arbitrary rate or decreases by a predetermined rate or an arbitrary rate.

11. A spiral coil comprising:
a conducting wire wound N turns,
wherein an interval between wires corresponding to each of sections of the conducting wire is configured to change in a direction from an outer radius of the spiral coil towards a center of the spiral coil such that a resistance of the spiral coil is minimized.

12. The spiral coil of claim 11, wherein, when the interval between the wires increases in the direction from the outer radius towards the center, widths of wires corresponding to two neighboring sections of the conducting wire are constant, or increase or decrease.

13. The spiral coil of claim 11, wherein, when the interval between the wires increases in the direction from the outer radius towards the center, a width difference between wires corresponding to two neighboring sections of the conducting wire is constant, or increases or decreases.

14. The spiral coil of claim 11, wherein, when the interval between the wires decreases in the direction from the outer radius towards the center, widths of wires corresponding to two neighboring sections of the conducting wire are constant, or increase or decrease.

15. The spiral coil of claim 11, wherein, when the interval between the wires decreases in the direction from the outer radius towards the center, a width difference between wires corresponding to two neighboring sections of the conducting wire is constant, or increases or decreases.

16.-18. (canceled)
